(19) United States
(12) Patent Application Publication
(10) Pub. No.: US 2018/0060886 A1
(43) Pub. Date: Mar. 1, 2018

(54) MARKET SHARE PREDICTION WITH SHIFTING CONSUMER PREFERENCE

(71) Applicant: INTERNATIONAL BUSINESS MACHINES CORPORATION, Armonk, NY (US)

(72) Inventors: Raphael EZRY, New York, NY (US); Munish GOYAL, Yorktown Heights, NY (US); Jingzi TAN, Chicago, IL (US); Shobhit VARSHNEY, Somers, NY (US)

(21) Appl. No.: 15/251,378

(22) Filed: Aug. 30, 2016

(51) Int. Cl. G06Q 30/02; G06F 17/30

(52) U.S. Cl. CPC G06Q 30/0202; G06F 17/30598

(57) ABSTRACT

Methods, computer program products, and systems are presented. The methods include, for instance: predicting a market share based on consumer preference shift based on inputs of including sales data of respective branded products in a market, product feature data, and product event data. Feature cluster switch rates are first estimated and then brand switch rate within a subject feature cluster is estimated. Future market share of a branded product having the subject feature cluster is predicted and reported.

### TECHNICAL FIELD

The present disclosure relates to predictive modeling and analytics, and more particularly to methods, computer program products, and systems for predicting impact on market share caused by shifting consumer preferences.

### BACKGROUND

In conventional market share analysis of a specific group of products that compete one another, numerous factors may influence changes in and paces of market share of one of the products. As consumer preferences shift with choices available in a market, various consumer selection behavior analyses are performed for market share prediction.

### SUMMARY

The shortcomings of the prior art are overcome, and additional advantages are provided, through the provision, in one aspect, of a method. The method for predicting a market share based on consumer preference shift includes, for example: obtaining, by one or more processor of a computer, inputs including sales data of respective branded products in a market, product feature data, and product event data; creating one or more feature clusters based on the product feature data; estimating switch rates at time t to a first feature cluster of the one or more feature clusters from the rest of respective feature clusters of the one or more feature clusters; estimating switch rates at time t to a first branded product in the first feature cluster from the rest of respective branded products in the first feature cluster; and predicting the market share of a first branded product of the first feature cluster at time (t+1) based on the estimated switch rates to the first feature cluster and the estimated switch rates to the first branded product.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for predicting a market share of a product as affected by shifting consumer preferences, in accordance with one or more embodiments set forth herein;

FIG. 2 depicts a switching example illustrating switching dynamics utilized in the switch rate predictions of the market share prediction engine, in accordance with one or more embodiments set forth herein;

FIG. 3 depicts a flowchart for the market share prediction engine, in accordance with one or more embodiments set forth herein;

FIG. 4 depicts a formula to estimate switch rates and market share progression, in accordance with one or more embodiments set forth herein;

FIG. 5A depicts estimated switch rates at time t and predicted switch rates at time (t+1) after an event from blocks 310 through 330 of FIG. 3, in accordance with one or more embodiments set forth herein;

FIG. 5B depicts market share graphs for a feature cluster and a brand in the feature cluster, in accordance with one or more embodiments set forth herein;

FIG. 6 depicts a cloud computing node according to an embodiment of the present invention;

FIG. 7 depicts a cloud computing environment according to an embodiment of the present invention; and

FIG. 8 depicts abstraction model layers according to an embodiment of the present invention.

### DETAILED DESCRIPTION

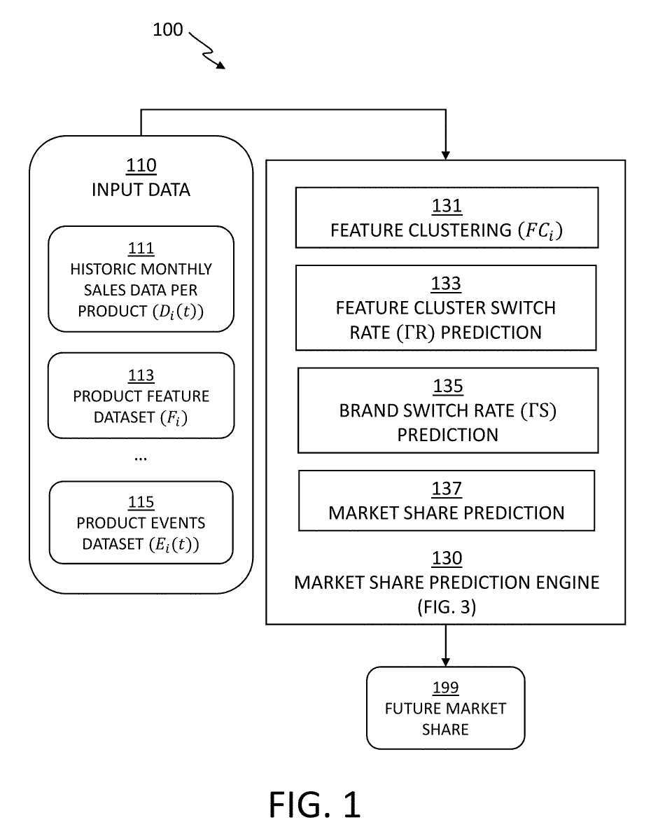

FIG. 1 depicts a system 100 for predicting a market share of a product as affected by shifting consumer preferences, in accordance with one or more embodiments set forth herein.

The system 100 for predicting the market share of a product as affected by shifting consumer preferences includes a market share prediction engine 130 that obtains input data 110 and creates a future market share 199 for the product. The input data 110 includes historical monthly sales data per product 111, a product feature dataset 113, and a product events dataset 115. The historical monthly sales data per product 111 is represented as Dᵢ(t), wherein i indicates respective product and t indicates the month of the historical monthly sales data per product 111. The product feature dataset 113 is represented as Fᵢ, wherein i indicates individual features present in the market of a type of product. The product events dataset 115 is represented as Eᵢ(t), wherein i indicates individual events at time t, in a monthly unit, of which value would be one (1) or TRUE if the event Eᵢ(t) occurs at time t, and of which value would be zero (0) or FALSE if the event Eᵢ(t) does not occur at time t.

The system 100 is to predict a market share of the product in a portfolio of branded products, from which consumers choose one of the branded products from the portfolio. The product and other branded products in the portfolio are regarded as competing, and the market share of the product would be calculated as a ratio of the sales for the product over the sales of all products in the portfolio, or the market. Consumer preferences may be based on what kind of features are present in the branded product and/or by which brand the branded product is made. The consumers may choose one feature and one brand at one purchase of a product from the portfolio and another feature and another brand for another product at a next purchase from the same portfolio. Also events affecting the market such as product recalls, new product launches, and a report of a safety issue with a product, etc., may influence the consumer preferences. Examples of markets for the branded products may be, but are not limited to, pharmaceutical products, wines, rental cars, hotel chains, etc. Manufacturers of branded products would benefit from information as to a rate of shifting consumer preferences on a feature or a group of features, a rate of loss in market share caused by a new product launch having the feature or the group of features in relation with respective brands, or by any other future events, and/or a sales of new products as entering the market.

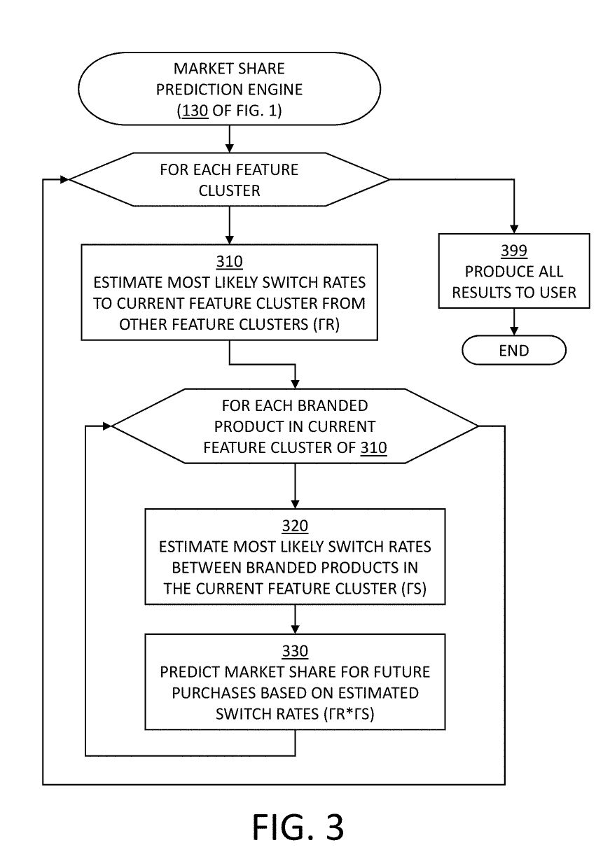

The market share prediction engine 130 includes a feature clustering process 131, a feature cluster switch rate (ΓR) prediction process 133, a brand switch rate (ΓS) prediction process 135, and a market share prediction process 137. The feature clustering process 131 groups certain features (Fᵢ) from the product feature dataset 113 into a feature cluster (FCᵢ) that indicates a representative feature characteristics of the product. Detailed operations of the feature cluster switch rate prediction, the brand switch rate prediction, and the market share prediction in the market share prediction engine 130 are presented in FIG. 3 and corresponding description.

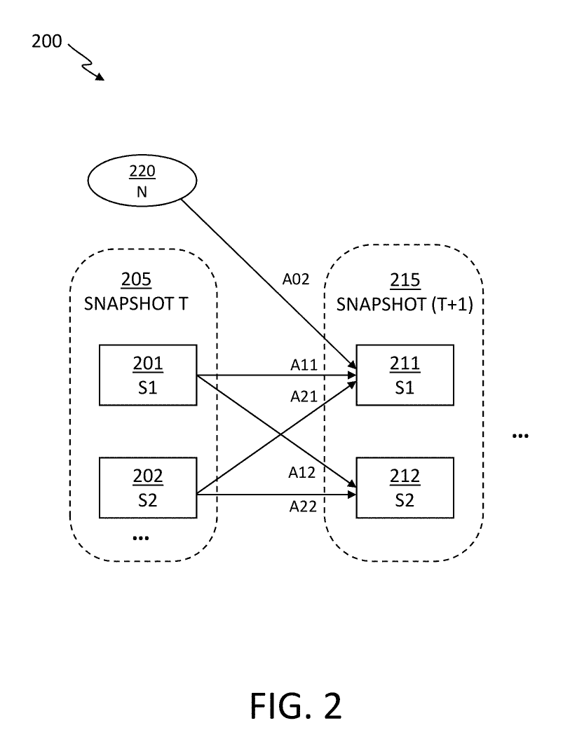

FIG. 2 depicts a switching example 200 illustrating state switch dynamics utilized in the switch rate predictions of the market share prediction engine 130 of FIG. 1, in accordance with one or more embodiments set forth herein.

The switching example 200 includes a first snapshot 205 at time t representing a first purchase of consumers and a second snapshot 215 at time (t+1) representing a second purchase of the consumers. The first snapshot 205 includes a first state S1 201 that is associated with a ratio of consumers who chose the first state S1 201 with their first purchases. The first snapshot 205 also includes a second state S2 202 that is associated with a ratio of consumers who chose the second state S2 201 with their first purchases.

The second snapshot 215 includes the first state S1 211 that is associated with a ratio of consumers who chose the first state S1 211 with their second purchases. The second snapshot 215 also includes the second state S2 212 that is associated with a ratio of consumers who chose the second state S2 212 with their second purchases.

For example of a product portfolio in a type of products, the first state S1 201 in the first snapshot 205 and the first state S1 211 in the second snapshot 215 may be a feature cluster of A. In the same example, the second state S2 202 in the first snapshot 205 and the second state S2 212 in the second snapshot 215 may be a feature cluster of B. In another example, the first state S1 201 in the first snapshot 205 and the first state S1 211 in the second snapshot 215 may be a brand product within the feature cluster of A, and the second state S2 202 and 212 in respective snapshots 205 and 215 may be another brand product within the same A feature cluster.

In the embodiments of the present invention, the same switching dynamics presented is applicable to both feature cluster switch rate prediction and brand switch rate prediction. Arrow A11 from the first state S1 201 in the first snapshot 205 to the first state S1 211 in the second snapshot 215 indicates a switch rate retained for the first state from the first purchase to the second purchase. Similarly, arrow A22 from the second state S2 202 in the first snapshot 205 to the second state S2 212 in the second snapshot 215 indicates a switch rate retained for the second state from the first purchase to the second purchase. Arrow A12 from the first state S1 201 in the first snapshot 205 to the second state S2 212 in the second snapshot 215 indicates a switch rate out of the first state S1 201 at the first purchase and into the second state S2 212 in the second purchase. Similarly, arrow A21 from the second state S2 202 in the first snapshot 205 to the first state S1 211 in the second snapshot 215 indicates a switch rate out of the second state S2 202 at the first purchase and into the first state S1 211 with the second purchase. Further, if a new volume that had not existed with the first purchase is present at the second purchase, represented by N 220, arrow A02 from the N 220 to the second state S2 212 in the second snapshot 215 indicates a rate of new purchases attracted to the second state S2 212. In one switching example wherein the states are respective feature clusters, the N 220 may be a sales volume increase between time t and time (t+1). In another switching example wherein the states are respective brands within a feature cluster, the N 220 may be a switch-in rate to the feature cluster at time (t+1) from other feature cluster at time t.

Wherein the states are respective feature clusters, respective notation R₀ᵢ indicates a rate in which new consumers select feature cluster i for their first purchases, Rᵢⱼ indicates a rate in which existing consumers switch out of feature cluster i and into feature cluster j, and Rᵢⱼindicates a rate in which existing consumers switch into feature cluster i and out of feature cluster j. Similarly, wherein the states are respective brands within a feature cluster, S₀ᵢ indicates a rate in which new consumers select brand i for their first purchases, Sᵢⱼ indicates a rate in which existing consumers switch out of brand i and into brand j, and Sⱼᵢ indicates a rate in which existing consumers switch into brand i and out of brand j.

FIG. 3 depicts a flowchart for the market share prediction engine 130 of FIG. 1, in accordance with one or more embodiments set forth herein.

In this embodiment of the present invention, a purchase decision by consumers are made in two-step, first a feature cluster based on needs, and then a brand within the feature cluster based on preferences. In other embodiments of the present invention, a purchase decision may be modeled as a brand selection in a first step and then a feature cluster of the selected brand, for types of purchases wherein a brand is a primary reason of the purchases.

The market share prediction engine 130 performs blocks 310, 320 and 330 for each feature cluster subject to analysis. Once all feature clusters are processed the market share prediction engine 130 proceeds with block 399.

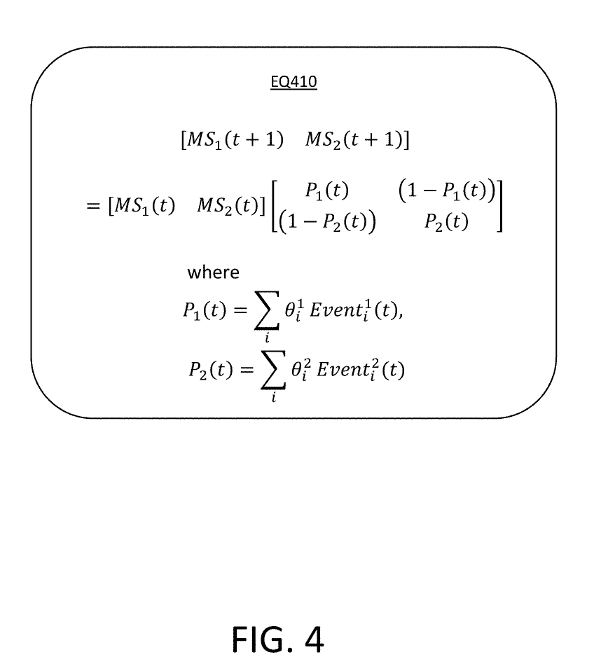

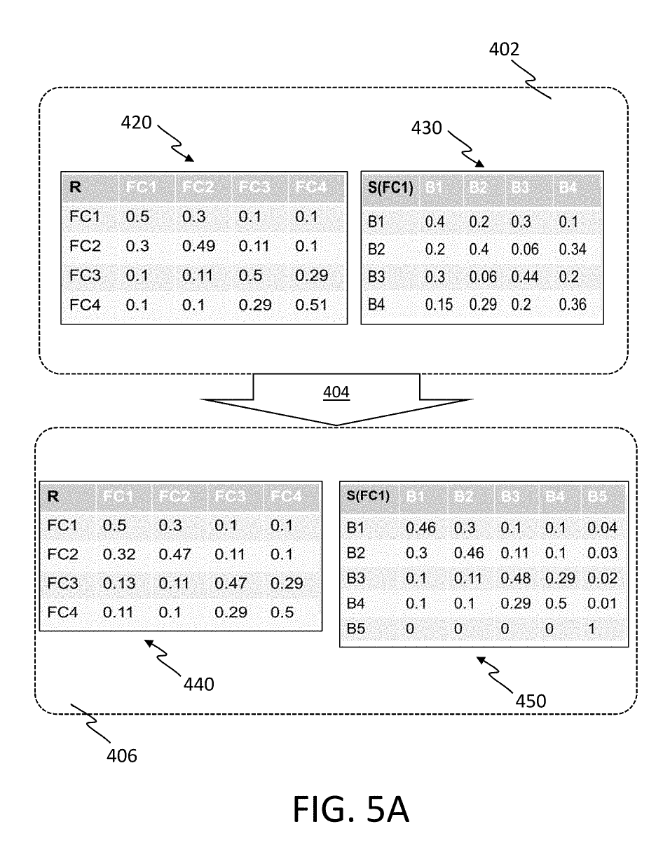

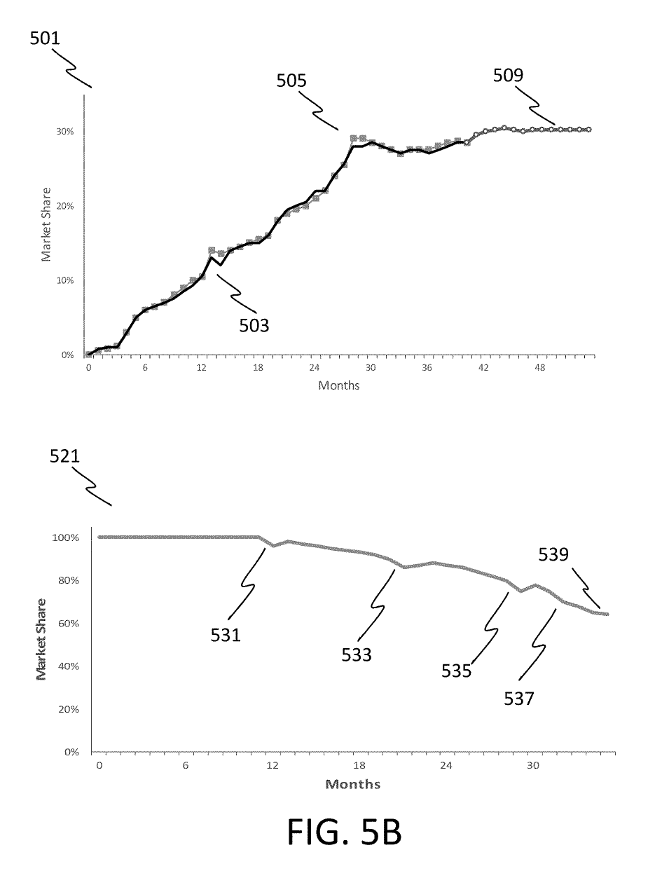

In block 310, the market share prediction engine 130 estimates most likely switch rates into a current feature cluster from other feature clusters, represented by (FR), according to Formula EQ410 of FIG. 4. An example of switch rates is described in FIG. 5A. Then the market share prediction engine 130 proceeds with block 320.

The market share prediction engine 130 performs blocks 320 and 330 as a unit for each branded product in the current feature cluster. In block 320, the market share prediction engine 130 estimates most likely switch rates into and out of all branded products in the current feature cluster, represented by (ΓS), according to Formula EQ410 of FIG. 4. An example of switch rates is described in FIG. 5A. Then the market share prediction engine 130 proceeds with block 330.

In block 330, the market share prediction engine 130 predicts future market share based on purchases as estimated by use of the switch rates in blocks 310 and 320, represented by (ΓR×ΓS). Then the market share prediction engine 130 proceeds with block 320 for next branded product in the current feature cluster. An example of switch rates is described in FIG. 5A. When the market share prediction engine 130 processes all branded products in the current feature cluster, then the market share prediction engine 130 proceeds with block 310 with a next feature cluster.

In block 399, the market share prediction engine 130 produces results from all blocks to a user for use and terminates processing.

FIG. 4 depicts a formula EQ410 to estimate switch rates and market share progression, in accordance with one or more embodiments set forth herein.

In formula EQ410, a future market share at time (t+1), the left term, is predicted by use of a current market share at time t and a state transition matrix of predicted switch rates, first and second argument of the right term, respectively. The formula EQ410 uses a two-by-two (2×2) Markov model in representing switches between two states. Switch rates at time t are given by P₁(t) and P₂(t), respectively determined as a parameter θ and predicted future event Event(t). The parameter θ is determined by a nonlinear optimization in order to minimize a squared error of the state transition matrix. The future event Event(t) is a binary value that is one (1), or True, if an event occurs at time t, or zero (0), or False, if an event does not occur at time t. Formula EQ410 is applicable to both block 310 in feature selection and block 320 in brand selection of FIG. 3.

FIG. 5A depicts estimated switch rates at time t and predicted switch rates at time (t+1) after an event from blocks 310 through 330 of FIG. 3, in accordance with one or more embodiments set forth herein.

In one embodiment of the present invention having four (4) feature clusters of FC1, FC2, FC3, and FC4, switch rates at time t 402 are represented by two tables 420 and 430. Switch rates into respective feature clusters of FC1, FC2, FC3, and FC4, (ΓR) at time t, are represented by table 420, wherein columns represent switch-in feature clusters and rows represent switch-out feature clusters. For example, switch rates into the first feature cluster FC1 from feature clusters FC1, FC2, FC3, and FC4 at time t are 0.5, 0.3, 0.1, and 0.1, respectively, as shown in the first column of table 420.

In the same embodiment, the first feature cluster FC1 has four (4) branded products of B1, B2, B3, and B4 at time t, and switch rates into and out of respective branded products, (ΓS) at time t, are represented by table 430, wherein columns represent switch-in brands/branded products and rows represent switch-out brands/branded products.

Arrow 404 represents an event that a new branded product B5 launched in the first feature cluster FC1. After the event 404, switch rates at time (t+1) 406 are represented by two tables 440 and 450.

Switch rates into respective feature clusters of FC1, FC2, FC3, and FC4, (ΓR) at time (t+1), are represented by table 440. For example, switch rates into the first feature cluster FC1 from feature clusters FC1, FC2, FC3, and FC4 at time (t+1) are 0.5, 0.32, 0.13, and 0.11, respectively, as shown in the first column of table 440, as affected by the new branded product B5 launched in the first feature cluster FC1.

Amongst the branded products of the first feature cluster FC1, switch rates into and out of respective branded products, B1, B2, B3, B4, and B5 at time (t+1), are represented by table 430. For example, switch rates into the new branded product B5 from the previously existing branded products, B1, B2, B3, and B4, of the first feature cluster FC1 at time (t+1) are 0.04, 0.03, 0.02, 0.01, and 1, respectively, as shown in the fifth column of table 450, as the new branded product B5 launched chipping the presented market shares away from respective branded products existed at time tin the first feature cluster FC1.

FIG. 5B depicts market share graphs for a feature cluster and a brand in the feature cluster, in accordance with one or more embodiments set forth herein.

A first market share graph 501 may represent market share of products having the feature cluster of A in a specific product market. A first line 503 is a historical predictive model fit of the feature cluster A market share. A second line 505 is actual feature cluster A market share. A third line 509 is a predicted market share of the feature cluster A.

A second market share graph 521 may represent market share of a branded product in the feature cluster A. The period corresponding to the flat line of the second market share graph 521 indicates that the branded product has the entire market share of the feature cluster A. A first mark 531 in the second market share graph 521 represents a launch of a first competitor product. A second, third and fourth marks, 533, 535, and 537, respectively, represents launches of distinctive competitor products. A fifth mark 539 in the second market share graph 521 represents that the branded product has less than seventy percent (70%) of feature cluster A market share by Month 36.

Certain embodiments of the present invention may offer various technical advantages, including hierarchical modeling of decision making process by consumers in multiple purchases, and prediction of future market share caused by preference shifts in a major category of a feature cluster and in a subcategory of a brand, based on the hierarchical modeling. Preference shift may be affected by favorable or unfavorable market events, and the market event effects to preference shift is taken into account in predicting probability of changes in consumer choices. Further by use of a nonlinear optimization, the impact of each market event on preference shift is isolated and individually accounted by parameter per market event. Certain embodiments of the present invention utilize Markov-chain based modeling in estimating switch rates amongst feature clusters based on observed aggregated sales data for each product and subsequently estimating switch rates amongst brands in a selected feature cluster based on observed aggregated sales data for each product within the feature cluster.

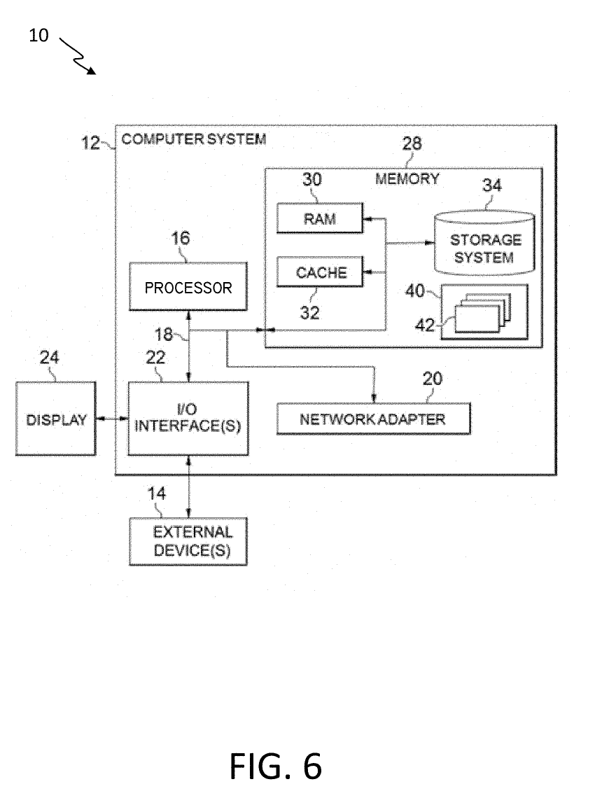

FIGS. 6-8 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 6, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the market share prediction engine 130 of FIG. 1. Program processes 42, as in the flowchart of FIG. 3, describing processes of the market share prediction engine 130, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

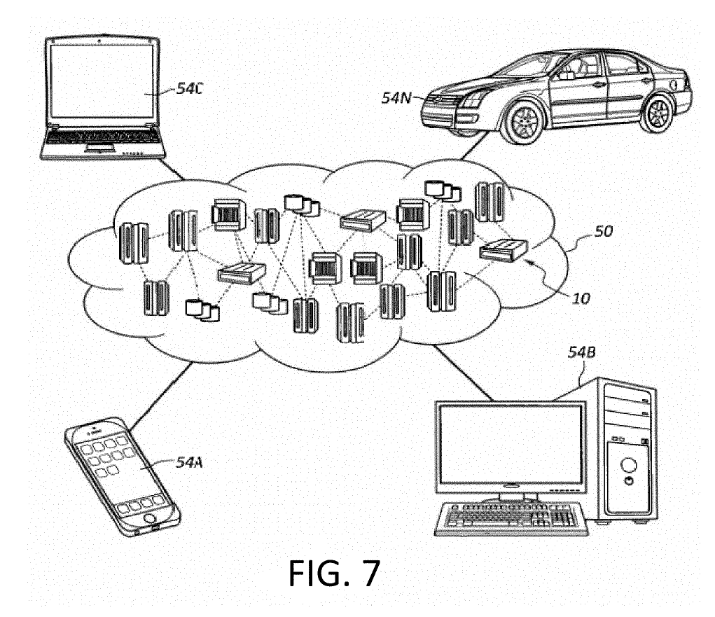

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 running one or more instances of the market share prediction engine 130 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

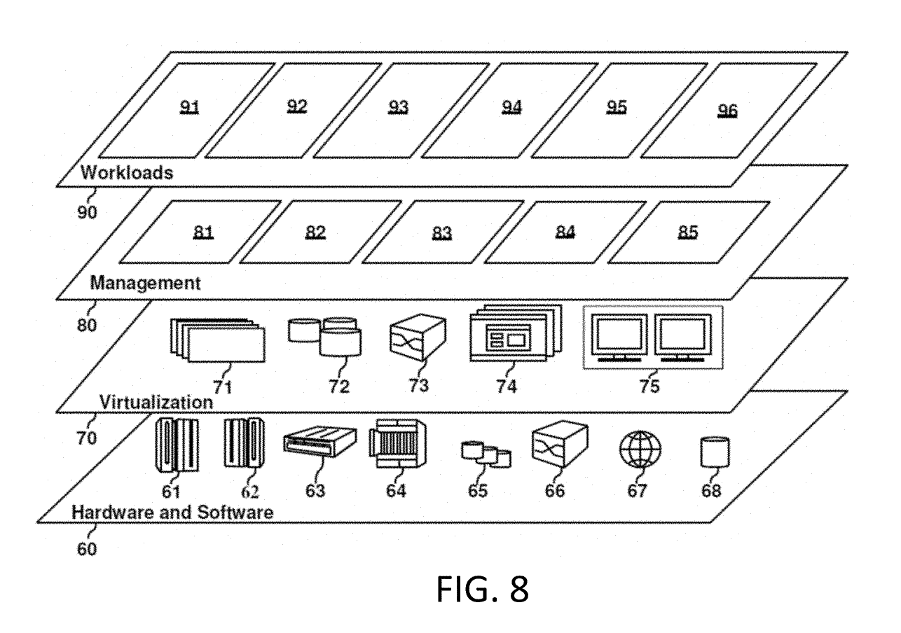

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the market share prediction engine 96, as described herein. The processing components 96 can be understood as one or more program 40 described in FIG. 6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for predicting a market share based on consumer preference shift, comprising:
obtaining, by one or more processor of a computer, inputs including sales data of respective branded products in a market, product feature data, and product event data;
creating one or more feature clusters based on the product feature data;
estimating switch rates at time t to a first feature cluster of the one or more feature clusters from the rest of respective feature clusters of the one or more feature clusters;
estimating switch rates at time t to a first branded product in the first feature cluster from the rest of respective branded products in the first feature cluster; and
predicting the market share of a first branded product of the first feature cluster at time (t+1) based on the estimated switch rates to the first feature cluster and the estimated switch rates to the first branded product.

2. The computer implemented method of claim 1, the estimating the switch rates to the first feature cluster comprising:
estimating a parameter for the switch rates to the first feature cluster from the rest of respective feature clusters;
predicting an event affecting the switch rates to the first feature cluster; and
calculating the switch rates to the first feature cluster at time t by adding all mathematical products of respective parameters at time t and respective events at time t.

3. The computer implemented method of claim 2, wherein the parameter for the switch rates to the first feature cluster from the rest of respective feature clusters is respectively determined to minimize a squared error of a state transition matrix of the switch rates.

4. The computer implemented method of claim 2, wherein the event affecting the switch rates to the first feature cluster is determined to one (1) if the event is predicted to occur or to zero (0) if the event is predicted not to occur.

5. The computer implemented method of claim 1, the estimating the switch rates to the first branded product in the first feature cluster comprising:
estimating a parameter for the switch rates to the first branded product from the rest of respective branded products in the first feature cluster;
predicting an event affecting the switch rates to the first branded product; and
calculating the switch rates to the first branded product at time t by adding all mathematical products of respective parameters at time t and respective events at time t.

6. The computer implemented method of claim 5, wherein the parameter for the switch rates to the first branded product from the rest of respective branded product is respectively determined to minimize a squared error of a state transition matrix of the switch rates.

7. The computer implemented method of claim 5, wherein the event affecting the switch rates to the first branded product is determined to one (1) if the event is predicted to occur or to zero (0) if the event is predicted not to occur.

8. A computer program product comprising:
a computer readable storage medium readable by one or more processor and storing instructions for execution by the one or more processor for performing a method for predicting a market share based on consumer preference shift, comprising:
obtaining, by the one or more processor, inputs including sales data of respective branded products in a market, product feature data, and product event data;
creating one or more feature clusters based on the product feature data;
estimating switch rates at time t to a first feature cluster of the one or more feature clusters from the rest of respective feature clusters of the one or more feature clusters;
estimating switch rates at time t to a first branded product in the first feature cluster from the rest of respective branded products in the first feature cluster; and
predicting the market share of a first branded product of the first feature cluster at time (t+1) based on the estimated switch rates to the first feature cluster and the estimated switch rates to the first branded product.

9. The computer program product of claim 8, the estimating the switch rates to the first feature cluster comprising:
estimating a parameter for the switch rates to the first feature cluster from the rest of respective feature clusters;
predicting an event affecting the switch rates to the first feature cluster; and
calculating the switch rates to the first feature cluster at time t by adding all mathematical products of respective parameters at time t and respective events at time t.

10. The computer program product of claim 9, wherein the parameter for the switch rates to the first feature cluster from the rest of respective feature clusters is respectively determined to minimize a squared error of a state transition matrix of the switch rates.

11. The computer program product of claim 9, wherein the event affecting the switch rates to the first feature cluster is determined to one (1) if the event is predicted to occur or to zero (0) if the event is predicted not to occur.

12. The computer program product of claim 8, the estimating the switch rates to the first branded product in the first feature cluster comprising:
estimating a parameter for the switch rates to the first branded product from the rest of respective branded products in the first feature cluster;
predicting an event affecting the switch rates to the first branded product; and
calculating the switch rates to the first branded product at time t by adding all mathematical products of respective parameters at time t and respective events at time t.

13. The computer program product of claim 12, wherein the parameter for the switch rates to the first branded product from the rest of respective branded product is respectively determined to minimize a squared error of a state transition matrix of the switch rates.

14. The computer program product of claim 12, wherein the event affecting the switch rates to the first branded product is determined to one (1) if the event is predicted to occur or to zero (0) if the event is predicted not to occur.

15. A system comprising:
a memory;
one or more processor in communication with memory; and
program instructions executable by the one or more processor via the memory to perform a method for predicting a market share based on consumer preference shift, comprising:
obtaining, by the one or more processor, inputs including sales data of respective branded products in a market, product feature data, and product event data;
creating one or more feature clusters based on the product feature data;
estimating switch rates at time t to a first feature cluster of the one or more feature clusters from the rest of respective feature clusters of the one or more feature clusters;
estimating switch rates at time t to a first branded product in the first feature cluster from the rest of respective branded products in the first feature cluster; and
predicting the market share of a first branded product of the first feature cluster at time (t+1) based on the estimated switch rates to the first feature cluster and the estimated switch rates to the first branded product.

16. The system of claim 15, the estimating the switch rates to the first feature cluster comprising:
estimating a parameter for the switch rates to the first feature cluster from the rest of respective feature clusters;
predicting an event affecting the switch rates to the first feature cluster; and
calculating the switch rates to the first feature cluster at time t by adding all mathematical products of respective parameters at time t and respective events at time t.

17. The system of claim 16, wherein the parameter for the switch rates to the first feature cluster from the rest of respective feature clusters is respectively determined to minimize a squared error of a state transition matrix of the switch rates.

18. The system of claim 16, wherein the event affecting the switch rates to the first feature cluster is determined to one (1) if the event is predicted to occur or to zero (0) if the event is predicted not to occur.

19. The system of claim 15, the estimating the switch rates to the first branded product in the first feature cluster comprising:
estimating a parameter for the switch rates to the first branded product from the rest of respective branded products in the first feature cluster;
predicting an event affecting the switch rates to the first branded product; and
calculating the switch rates to the first branded product at time t by adding all mathematical products of respective parameters at time t and respective events at time t.

20. The system of claim 19, wherein the parameter for the switch rates to the first branded product from the rest of respective branded product is respectively determined to minimize a squared error of a state transition matrix of the switch rates, and wherein the event affecting the switch rates to the first branded product is determined to one (1) if the event is predicted to occur or to zero (0) if the event is predicted not to occur.
